(19) United States
(12) Patent Application Publication
(10) Pub. No.: US 2026/0074430 A1
(43) Pub. Date: Mar. 12, 2026

(54) ANTENNA STRUCTURE AND ELECTRONIC DEVICE

(71) Applicant: WNC Corporation, Hsinchu (TW)

(72) Inventors: Tzu-Kuan SUN, Hsinchu (TW); Ching-Wen CHEN, Hsinchu (TW); Jen-Chao LU, Hsinchu (TW); Shih-Kai HSU, Hsinchu (TW)

(21) Appl. No.: 19/312,492

(22) Filed: Aug. 28, 2025

Related U.S. Application Data
(60) Provisional application No. 63/691,498, filed on Sep. 6, 2024.

(30) Foreign Application Priority Data
Jan. 22, 2025 (TW) 114102887

(51) Int. Cl. H01Q 13/10; H01Q 1/22; H01Q 9/30; H01Q 19/00

(52) U.S. Cl. CPC H01Q 13/106; H01Q 1/2266; H01Q 9/30; H01Q 19/005

(57) ABSTRACT

An antenna structure includes a signal unit, a first ground unit, a second ground unit and a parasitic unit. The signal unit is configured for disposing a feed port thereon. The first ground unit is disposed correspondingly to the signal unit and configured to be connected to a system ground. The second ground unit is separated from the first ground unit and configured to be connected to the system ground. The parasitic unit is adjacent to the second ground unit and configured to be coupled to the first ground unit. The signal unit, the first ground unit, the second ground unit and the parasitic unit are made of the same or different conductive materials.

### RELATED APPLICATIONS

This application claims the benefit of priorities to US Provisional Application Number 63/691,498, filed on Sep. 6, 2024, and Taiwan Application Number 114102887, filed on Jan. 22, 2025. The entire content of the above identified applications are incorporated herein by reference.

### BACKGROUND

### Technical Field

The present disclosure relates to an antenna structure and an electronic device, and more particularly, to an antenna structure and an electronic device with two ground units.

### Description of Related Art

With the advancement of technology, the demand for functional characteristics and aesthetic appearance of electronic devices has been increasing. As a result, the components within electronic devices need to be arranged more densely, which limits the space available for antennas or brings antennas too close to adjacent components. This leads to mutual interference between the antenna and adjacent components, thereby affecting their functional characteristics.

In view of the above, there is a need to develop an antenna structure and electronic device that can overcome limited space constraints and reduce mutual interference between the antenna and adjacent components.

### SUMMARY

The present disclosure provides an antenna structure and an electronic device, where the antenna structure includes a signal unit, a first ground unit, a second ground unit, and a parasitic unit. The first ground unit is disposed corresponding to the signal unit, and the second ground unit is separated from the first ground unit. Through the parasitic unit being adjacent to the second ground unit and coupling or connecting to at least one of the first ground unit and the signal unit, it assists the second ground unit in serving as a radiating element of the antenna structure. The second ground unit may or may not be an existing conductive component within the electronic device.

In one aspect, the present disclosure provides an antenna structure that includes a signal unit, a first ground unit, a second ground unit, and a parasitic unit. The signal unit is configured for disposing a feed port thereon. The first ground unit is disposed corresponding to the signal unit and is configured to be connected to a system ground. The second ground unit is separated from the first ground unit and configured to be connected to the system ground. The parasitic unit is adjacent to the second ground unit and configured to be coupled to the first ground unit. The signal unit, the first ground unit, the second ground unit, and the parasitic unit are made of the same or different conductive materials.

In another aspect, the present disclosure provides an antenna structure that includes a signal unit, a first ground unit, a second ground unit, and a parasitic unit. The signal unit is configured for disposing a feed port thereon. The first ground unit is disposed corresponding to the signal unit and is configured to be connected to a system ground. The second ground unit is separated from the first ground unit and configured to be connected to the system ground. The parasitic unit is adjacent to the second ground unit and configured to be coupled or connected to the signal unit. The signal unit, the first ground unit, the second ground unit, and the parasitic unit are made of the same or different conductive materials.

In yet another aspect, the present disclosure provides an electronic device that includes a system ground, a module, a signal unit, a first ground unit, and a parasitic unit. The module includes a second ground unit, which is a metal casing connected to the system ground. The signal unit includes a feed port. The first ground unit is disposed corresponding to the signal unit and connected to the system ground, and the second ground unit is separated from the first ground unit. The parasitic unit is adjacent to the second ground unit and configured to be coupled or connected to at least one of the first ground unit and the signal unit.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an antenna structure according to a first embodiment of the present disclosure.

FIG. 2 is a schematic diagram an antenna structure according to a second embodiment of the present disclosure.

FIG. 3 is a schematic diagram of an antenna structure according to a third embodiment of the present disclosure.

FIG. 4 is a schematic diagram of an electronic device according to a fourth embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

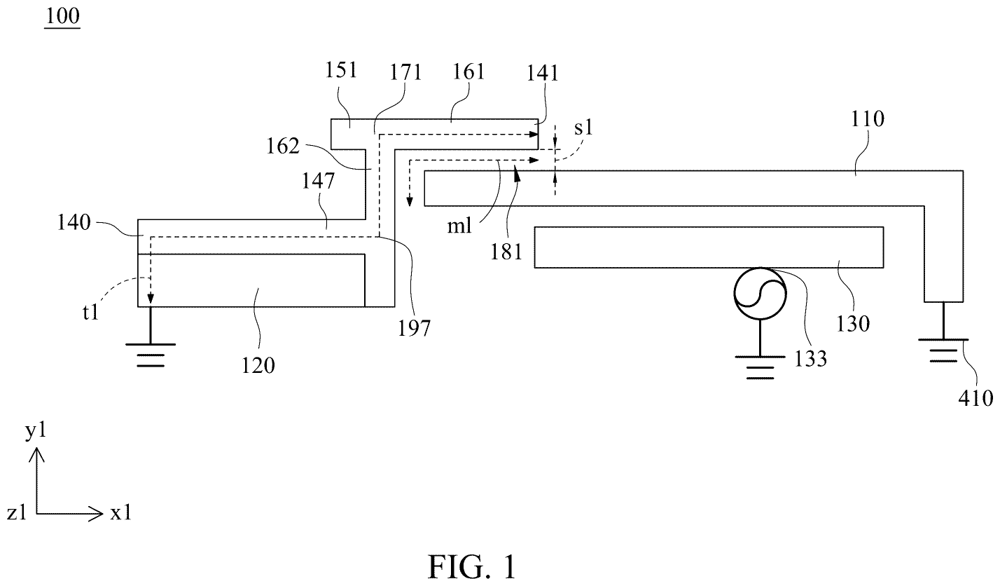

FIG. 1 illustrates a schematic diagram of an antenna structure 100 according to a first embodiment of the present disclosure. Referring to FIG. 1, the antenna structure 100 includes a signal unit 130, a first ground unit 110, a second ground unit 120 and a parasitic unit 140.

The signal unit 130 is configured for disposing a feed port 133. The first ground unit 110 is disposed corresponding to the signal unit 130 and is configured to be connected to a system ground 410. When the antenna structure 100 is disposed in an electronic device, such as the electronic device 400 of the fourth embodiment, the system ground 410 is the ground of the electronic device 400. The second ground unit 120 is separated from the first ground unit 110 and is configured to be connected to the system ground 410, meaning that the structures of the first ground unit 110 and the second ground unit 120 are separated, and when the antenna structure 100 is disposed in the electronic device 400, both the first ground unit 110 and the second ground unit 120 are connected to the system ground 410 of the electronic device 400. The parasitic unit 140 is adjacent to the second ground unit 120 and configured to be coupled to the first ground unit 110. The signal unit 130, the first ground unit 110, the second ground unit 120, and the parasitic unit 140 are made of the same or different conductive materials. As such, the second ground unit 120 is facilitated to be in conjunction with the parasitic unit 140 to serve as a radiating element of the antenna structure 100, where the second ground unit 120 may or may not be an existing conductive component in the electronic device 400. For example, the antenna structure 100 can be used in an LTE wireless communication system, and the length of the second ground unit 120 along the first direction x1 can range between 25 mm and 45 mm. Furthermore, the term “connect” in this disclosure refers to a physical connection between two elements that is either direct or indirect, while the term “couple” refers to two elements being separated and not physically connected, where the electric field energy generated by the current of one element excites the electric field energy of another element.

Specifically, the parasitic unit 140 may include a first coupling portion 141 that is coupled to the first ground unit 110. As such, the antenna structure 100 has better resistance to environmental interference.

The length m1 of a gap 181 between the first coupling portion 141 and the first ground unit 110 can range between 5 mm and 20 mm. Hence, the antenna structure 100 can balance design size and operating frequency band requirements.

The distance s1 of the gap 181 between the first coupling portion 141 and the first ground unit 110 can range between 0.1 mm and 2 mm, so as to assist the antenna structure 100 in having appropriate coupling energy and bandwidth.

The parasitic unit 140 may further include a connecting portion 147, which connects to the second ground unit 120, with one end (not otherwise labeled) of the first coupling portion 141 connected to one end 197 of the connecting portion 147. The connecting portion 147 extends from the end 197 of the connecting portion 147 along the first direction x1, and the other end (not otherwise labeled) of the first coupling portion 141 is an open end. The total length t1 (as shown in FIG. 1) of the length of the first coupling portion 141, the length of the connecting portion 147, and the length of the second ground unit 120 along the second direction y1 can range between 20 mm and 60 mm. Specifically, the total length t1 is the length from the open end of the first coupling portion 141 to the connection position of the second ground unit 120 with the system ground 410. Therefore, the parasitic unit 140 and the second ground unit 120 can contribute to the required operating frequency band under size requirements, such as the frequency band of 1.71 GHz to 2.69 GHz in an LTE system.

The parasitic unit 140 may further include a first stub portion 151, and the first coupling portion 141 includes a corner 171. The first stub portion 151 and a first segment 161 of the first coupling portion 141 are connected at the corner 171 and extend into open ends along two opposite directions (for example, the negative and positive directions of the first direction x1 in FIG. 1). Thus, the first stub portion 151 assists in fine-tuning the operating frequency band, especially when the second ground unit 120 is an existing conductive component in the electronic device 400, the second ground unit 120 has a significant impact on the impedance matching of the antenna structure 100. By using the first stub portion 151, it assists in adjusting and forming the impedance of the first coupling portion 141, the connecting portion 147, and the second ground unit 120 with the total length t1, while also assisting in increasing bandwidth. Specifically, the first coupling portion 141 includes the first segment 161 and a second segment 162, with the first segment 161 and the second segment 162 connected at the corner 171. The first segment 161 extends from the corner 171 along the first direction x1 into an open end, and the second segment 162 extends from the corner 171 along the second direction y1 and connects to the connecting portion 147.

The second ground unit 120 may be a metal casing, such as the metal casing of the module 420 in the electronic device 400 of the fourth embodiment, where the module 420 can be a camera module or another module, with the metal casing used for electromagnetic shielding, though not limited thereto. Therefore, the antenna structure 100 can make good use of existing conductive components in the electronic device 400 and achieve the antenna size and operating frequency band requirements.

A part of the parasitic unit 140 may be a trace on a circuit board, while another part of the parasitic unit 140 may be manufactured through Laser Direct Structuring (LDS), with the part connected to the other part. Therefore, the antenna structure 100 does not add additional design and manufacturing burdens to the electronic device 400. For example, in the first embodiment of the antenna structure 100, the connecting portion 147 of the parasitic unit 140 may be a conductive trace or copper foil on the circuit board, and the first coupling portion 141 and the first stub portion 151 of the parasitic unit 140 may be conductive material formed by LDS on a plastic carrier, with the first coupling portion 141 electrically connected to the connecting portion 147 by micro-welding, though the present disclosure is not limited thereto. Additionally, the second ground unit 120 is electrically connected to the connecting portion 147 by welding or conductive adhesive lapping process, and the signal unit 130 and the first ground unit 110 in the antenna structure 100 may be conductive material formed by LDS on a plastic carrier, though the present disclosure is not limited thereto.

Furthermore, in the embodiments of the present disclosure, the shapes of the signal unit, the first ground unit, the second ground unit, and the parasitic unit in the antenna structure are not limited to those illustrated in the drawings, and the shapes of each said unit are not limited to extending or distributing in the plane formed by the first direction x1 and the second direction y1, at least part of any said unit are also able to extend or distribute along the third direction z1.

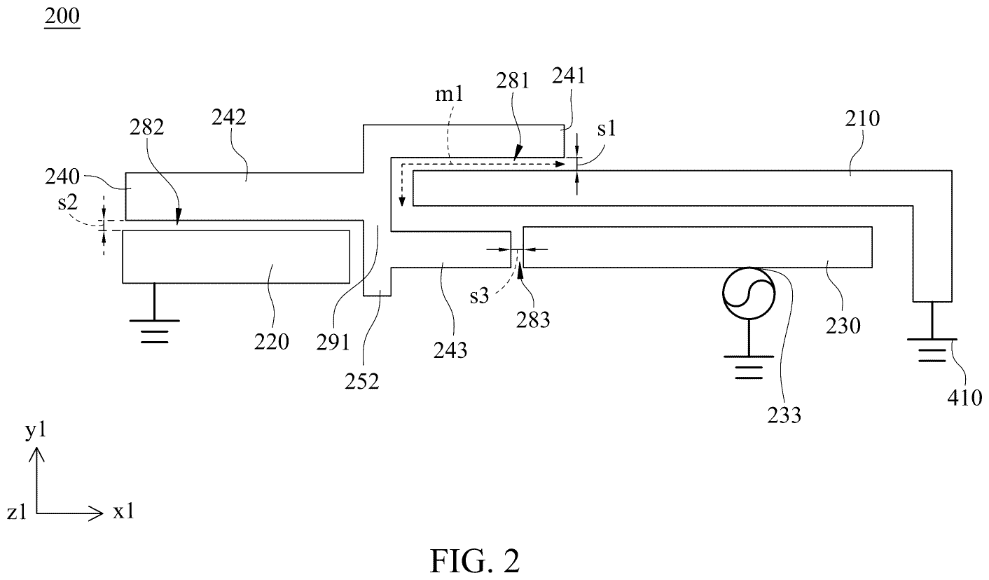

FIG. 2 illustrates a schematic diagram of an antenna structure 200 according to the second embodiment of the present disclosure. Referring to FIG. 2, the antenna structure 200 includes a signal unit 230, a first ground unit 210, a second ground unit 220 and a parasitic unit 240.

The signal unit 230 is configured for disposing a feed port 233 thereon. The first ground unit 210 is disposed corresponding to the signal unit 230 and is configured to be connected to a system ground (such as the system ground 410 of the electronic device 400 in the fourth embodiment). The second ground unit 220 is separated from the first ground unit 210 and is configured to be connected to the system ground 410. The parasitic unit 240 is adjacent to the second ground unit 220 and configured to be coupled to the first ground unit 210. Specifically, in the second embodiment of the antenna structure 200, the parasitic unit 240 couples the first ground unit 210. The signal unit 230, the first ground unit 210, the second ground unit 220, and the parasitic unit 240 are made of the same or different conductive materials. Therefore, the second ground unit 220 serves as a radiating element of the antenna structure 200, and the second ground unit 220 may or may not be an existing conductive component in the electronic device 400.

Specifically, the parasitic unit 240 includes a first coupling portion 241, which couples the first ground unit 210. The length m1 of a gap 281 between the first coupling portion 241 and the first ground unit 210 is between 5 mm and 20 mm, and the distance s1 of the gap 281 between the first coupling portion 241 and the first ground unit 210 is between 0.1 mm and 2 mm.

The parasitic unit 240 may further include a second coupling portion 242, which couples to the second ground unit 220, with the distance s2 of a gap 282 between the second coupling portion 242 and the second ground unit 220 being between 0.1 mm and 1 mm. One end 291 of the first coupling portion 241 connects to one end (not otherwise labeled) of the second coupling portion 242, with the other end (not otherwise labeled) of the first coupling portion 241 and the other end (not otherwise labeled) of the second coupling portion 242 both being open ends. Thus, the main pattern formed by the signal unit 230 and the first ground unit 210 in the antenna structure 200 is coupled to the second coupling portion 242 through the first coupling portion 241 and the third coupling portion 243. The second coupling portion 242 is not connected and coupled to the second ground unit 220, and the second coupling portion 242 is in a floating ground state, which assists in increasing bandwidth. Furthermore, the distance s2 between 0.1 mm and 1 mm has the effect of equivalent capacitance, which can further assist in increasing bandwidth.

The parasitic unit 240 may further include a third coupling portion 243, which couples to the signal unit 230. Furthermore, the distance s3 of a gap 283 between the third coupling portion 243 and the signal unit 230 can be between 0.1 mm and 5 mm, with one end 291 of the first coupling portion 241 connecting to one end (not otherwise labeled) of the third coupling portion 243. Thus, it is favorable to the coupling energy of the second coupling portion 242. Moreover, the main pattern formed by the signal unit 230 and the first ground unit 210 coupled with the third coupling portion 243 can further increase coupling energy and enhance the efficiency of the operating frequency band corresponding to the parasitic unit 240.

The parasitic unit 240 may further include a second stub portion 252. The second stub portion 252 and the first coupling portion 241 are connected at the end 291 of the first coupling portion 241 and extend in two opposite directions (for example, the negative and positive directions of the second direction y1 in FIG. 2). Therefore, the second stub portion 252 assists in adjusting impedance matching to achieve the required operating frequency band.

The second ground unit 220 is a metal casing, such as the metal casing of the module 420 in the electronic device 400 of the fourth embodiment. A part of the parasitic unit 240 is a trace on a circuit board, while another part of the parasitic unit 240 is manufactured through laser direct structuring, with the said part connected to the said other part.

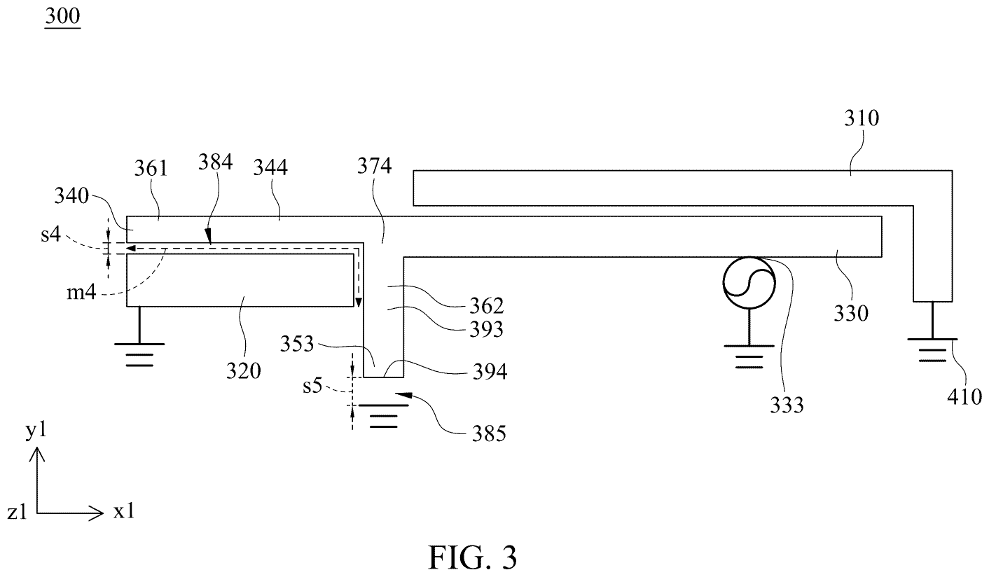

FIG. 3 illustrates a schematic diagram of an antenna structure 300 according to the third embodiment of the present disclosure. Referring to FIG. 3, the antenna structure 300 includes a signal unit 330, a first ground unit 310, a second ground unit 320 and a parasitic unit 340.

The signal unit 330 is configured for disposing a feed port 333. The first ground unit 310 is disposed corresponding to the signal unit 330 and is configured to be connected to a system ground (such as the system ground 410 of the electronic device 400 in the fourth embodiment). The second ground unit 320 is separated from the first ground unit 310 and is configured to be connected to the system ground 410. The parasitic unit 340 is adjacent to the second ground unit 320 and configured to be connected to the signal unit 330. Specifically, in the third embodiment of the antenna structure 300, the parasitic unit 340 is connected to the signal unit 330. The signal unit 330, the first ground unit 310, the second ground unit 320 and the parasitic unit 340 are made of the same or different conductive materials. Thus, the second ground unit 320 serves as a radiating element of the antenna structure 300, and the second ground unit 320 may or may not be an existing conductive component in the electronic device 400. For example, the antenna structure 300 can be used in an LTE system, with the parasitic unit 340 and the second ground unit 320 coupling to resonate at the high-frequency band of 3.3 GHz to 3.8 GHz in the LTE system, and the length of the second ground unit 320 along the first direction x1 can range between 25 mm and 45 mm.

Specifically, the parasitic unit 340 may include a fourth coupling portion 344, which couples the second ground unit 320, with the length m4 of a gap 384 between the fourth coupling portion 344 and the second ground unit 320 being between 20 mm and 45 mm, and the distance s4 of the gap 384 being between 0.1 mm and 2 mm. Therefore, the antenna structure 300 can have appropriate coupling energy and bandwidth.

The fourth coupling portion 344 can connect to the signal unit 330. Therefore, the convenience of design and manufacturing is enhanced.

The parasitic unit 340 may further include a third stub portion 353. The fourth coupling portion 344 is divided by a corner 374 into a first segment 361 and a second segment 362. One end of the first segment 361, one end of the second segment 362, and one end of the signal unit 330 are connected at the corner 374, with the other end of the first segment 361 and the other end of the signal unit 330 both being open ends, and the other end of the second segment 362 connecting to one end 393 of the third stub portion 353. Therefore, the third stub portion 353 assists in adjusting impedance matching to achieve the required operating frequency band.

The distance s5 of a gap 385 between one end 394 of the third stub portion 353 and the system ground 410 is between 0.5 mm and 5 mm. Therefore, the distance s5 of the gap 385 between the third stub portion 353 and the system ground 410 has the effect of equivalent capacitance, which assists in increasing bandwidth.

The second ground unit 320 is a metal casing, such as the metal casing of the module 420 in the electronic device 400 of the fourth embodiment. A part of the parasitic unit 340 is a trace on a circuit board, while another part of the parasitic unit 340 is manufactured through laser direct structuring, with the said part connected to the said other part. Alternatively, the entire parasitic unit 340 can be a trace on a circuit board. For example, in the third embodiment of the antenna structure 300, the first segment 361 of the fourth coupling portion 344 of the parasitic unit 340 can be a conductive trace or copper foil on the circuit board, while the second segment 362 of the fourth coupling portion 344 of the parasitic unit 340 and the third stub portion 353 can be conductive material formed by LDS on a plastic carrier, with the first segment 361 and the second segment 362 electrically connected by micro-welding, though the present disclosure is not limited thereto. Furthermore, the signal unit 330 and the first ground unit 310 in the antenna structure 300 can be conductive material formed by LDS on a plastic carrier, though the present disclosure is not limited thereto.

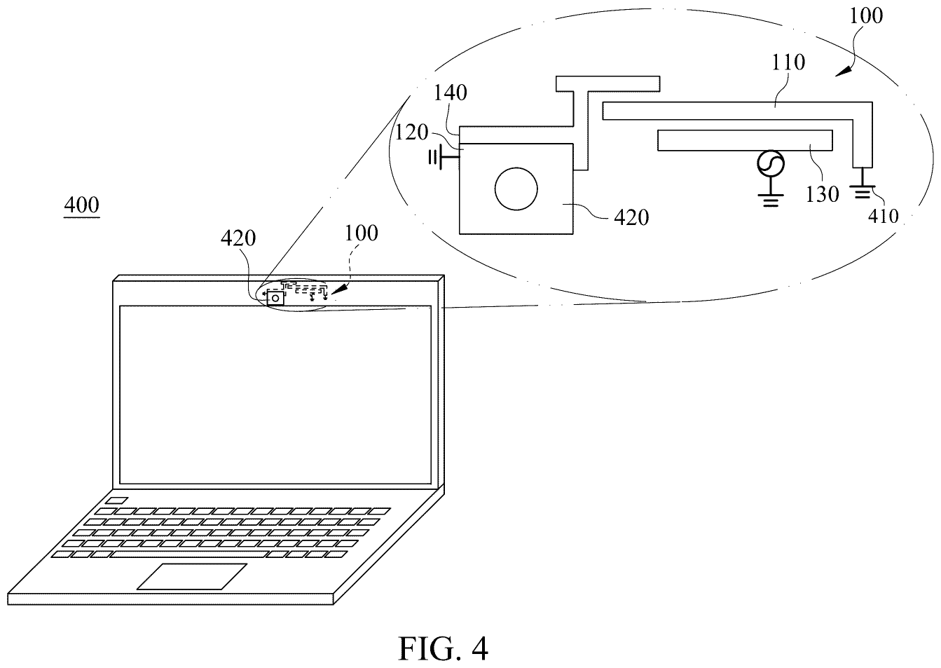

FIG. 4 illustrates a schematic diagram of the electronic device 400 according to the fourth embodiment of the present disclosure. Referring to FIG. 1 and FIG. 4, the electronic device 400 includes a system ground 410, a module 420, a signal unit 130, a first ground unit 110, and a parasitic unit 140, where the electronic device 400 specifically includes the antenna structure according to the present disclosure (such as the antenna structure 100 of the first embodiment) and can be a notebook computer, though the present disclosure is not limited thereto. The module 420 includes a second ground unit 120, which is a metal casing connected to the system ground 410. The signal unit 130 includes a feed port 133. The first ground unit 110 is disposed corresponding to the signal unit 130 and connected to the system ground 410, with the second ground unit 120 separated from the first ground unit 110. The parasitic unit 140 is adjacent to the second ground unit 120 and coupled or connected to at least one of the first ground unit 110 and the signal unit 130. Therefore, as the demand for functional characteristics and aesthetic appearance of the electronic device 400 increases, such as the screen bezel of the electronic device 400 becoming narrower, the antenna design in the prior art becomes more challenging. When antennas in the conventional technology are placed on at least one side of the module 420, they often interfere with the module 420. However, according to the electronic device 400 and its antenna structure 100 of the present disclosure, the metal casing (second ground unit 120) of the module 420 can be used as a radiating element (such as a mid-frequency radiating element) of the antenna structure 100, thereby achieving the design of the full frequency band of the wireless communication system (such as the LTE system), for example, serving as a radiating element for the frequency band of 1.71 GHz to 2.69 GHz in the LTE system, though the present disclosure is not limited thereto.

Particularly, the module 420 can be a camera module, which can include a lens assembly, an electronic photosensitive element (Image Sensor), and an imaging signal processing element (ISP). Specifically, the circuit board of the module 420 is divided into a punch area (not shown in the figure) and a lap area, with the lap area copper-plated and possibly including the connecting portion 147 of the antenna structure 100. The lap area overlaps with the micro-welding position to electrically connect the first coupling portion 141 and the connecting portion 147 by micro-welding. The connecting portion 147 in the antenna structure 100 is electrically connected to the module ground of the module 420 (which includes the second ground unit 120) and then electrically connected to the ground of the main board of the electronic device 400 through a connector to electrically connect to the system ground 410 of the electronic device 400. Furthermore, the module 420 can also be an image sensor or a module containing an image sensor. Hence, it assists in maintaining the normal function of the antenna structure 100 and the module 420 under the limited space design requirements of the electronic device 400, further increasing the bandwidth of the antenna structure 100.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna structure comprising:
a signal unit configured for disposing a feed port;
a first ground unit disposed corresponding to the signal unit and configured to be connected to a system ground;
a second ground unit separated from the first ground unit and configured to be connected to the system ground; and
a parasitic unit adjacent to the second ground unit and configured to be coupled to the first ground unit;
wherein the signal unit, the first ground unit, the second ground unit, and the parasitic unit are made of the same or different conductive materials.

2. The antenna structure according to claim 1, wherein the second ground unit is a metal casing.

3. The antenna structure according to claim 1, wherein a part of the parasitic unit is a trace on a circuit board, and another part of the parasitic unit is formed through laser direct structuring, and the part is connected to the other part.

4. The antenna structure according to claim 1, wherein the parasitic unit comprises a first coupling portion coupled to the first ground unit.

5. The antenna structure according to claim 4, wherein a length of a gap between the first coupling portion and the first ground unit is between 5 mm and 20 mm.

6. The antenna structure according to claim 4, wherein a distance of a gap between the first coupling portion and the first ground unit is between 0.1 mm and 2 mm.

7. The antenna structure according to claim 4, wherein the parasitic unit further comprises a connecting portion connected to the second ground unit, one end of the first coupling portion is connected to one end of the connecting portion, the connecting portion extends from the end along a first direction, and a total length of the first coupling portion, the connecting portion, and the second ground unit is between 20 mm and 60 mm.

8. The antenna structure according to claim 4, wherein the parasitic unit further comprises a first stub portion, the first coupling portion comprises a corner, the first stub portion is connected to a first segment of the first coupling portion at the corner, and the first stub portion and the first segment extend in two opposite directions.

9. The antenna structure according to claim 4, wherein the parasitic unit further comprises a second coupling portion coupled to the second ground unit, a distance of a gap between the second coupling portion and the second ground unit is between 0.1 mm and 1 mm, and one end of the first coupling portion is connected to one end of the second coupling portion.

10. The antenna structure according to claim 9, wherein the parasitic unit further comprises a third coupling portion coupled to the signal unit, a distance of a gap between the third coupling portion and the signal unit is between 0.1 mm and 5 mm, and the end of the first coupling portion is connected to one end of the third coupling portion.

11. The antenna structure according to claim 9, wherein the parasitic unit further comprises a second stub portion, the second stub portion is connected to the end of the first coupling portion, and the second stub portion and the first coupling portion extend in two opposite directions.

12. An antenna structure comprising:
a signal unit configured for disposing a feed port;
a first ground unit disposed corresponding to the signal unit and configured to be connected to a system ground;
a second ground unit separated from the first ground unit and configured to be connected to the system ground; and
a parasitic unit adjacent to the second ground unit and configured to be coupled or connected to the signal unit;
wherein the signal unit, the first ground unit, the second ground unit, and the parasitic unit are made of the same or different conductive materials.

13. The antenna structure according to claim 12, wherein the second ground unit is a metal casing.

14. The antenna structure according to claim 12, wherein the parasitic unit comprises a fourth coupling portion coupled to the second ground unit, a length of a gap between the fourth coupling portion and the second ground unit is between 20 mm and 45 mm, and a distance of the gap is between 0.1 mm and 2 mm.

15. The antenna structure according to claim 12, wherein the parasitic unit comprises a fourth coupling portion coupled to the second ground unit, and the fourth coupling portion is connected to the signal unit.

16. The antenna structure according to claim 15, wherein the parasitic unit further comprises a third stub portion, the fourth coupling portion is divided by a corner into a first segment and a second segment, one end of the first segment, one end of the second segment, and one end of the signal unit are connected at the corner, and another end of the second segment is connected to one end of the third stub portion.

17. The antenna structure according to claim 16, wherein a distance of a gap between another end of the third stub portion and the system ground is between 0.5 mm and 5 mm.

18. The antenna structure according to claim 12, wherein the parasitic unit comprises a third coupling portion coupled to the signal unit.

19. An electronic device comprising:
a system ground;
a module comprising a second ground unit, which is a metal casing connected to the system ground;
a signal unit comprising a feed port;
a first ground unit disposed corresponding to the signal unit and connected to the system ground, wherein the second ground unit is separated from the first ground unit; and
a parasitic unit adjacent to the second ground unit and configured to be coupled or connected to at least one of the first ground unit and the signal unit.

20. The electronic device according to claim 19, wherein the module is a camera module.
